(19) United States
(12) Patent Application Publication
(10) Pub. No.: US 2005/0010541 A1
(43) Pub. Date: Jan. 13, 2005

(54) Method and system for computing categories and prediction of categories utilizing time-series classification data

(76) Inventor: Edward A. Rietman, Nashua, NH (US)

Correspondence Address: Pepper Hamilton LLP;One Mellon Center, 50th Floor, 500 Grant Street, Pittsburgh, PA, 15219, US

(21) Appl. No.: 10/886,525

(22) Filed: Jul. 7, 2004

Related U.S. Application Data
(60) Provisional application No. 60/485,326, filed on Jul. 7, 2003.

(51) Int. Cl. G06F 15/18

(52) U.S. Cl. 706/12

(57) ABSTRACT

The present invention relates to methods for mining real-world databases that have mixed data types (e.g., scalar, binary, category, etc.) to extract an implicit time-sequence to the data and to utilize the extracted information to compute categories for the input data and to predict categorization of future input data vectors. Many real-world databases may not have explicit time data yet there may be inherent time data which may be extracted from the database itself. The present invention extracts such inherent time sequence data and utilizes it to classify the data vectors at each instant in time for purposes of categorizing the data at that time instant. The present invention has wide applicability and may find use in fields such as manufacturing, financial services, or government. In particular, the present invention may be used to identify potential threats, to predict the presence of a threat, and even to evaluate the degree of threat posed. For purposes of this discussion, the threats may be security threats or other adverse events occurring at a particular company, location, or systems, such as a manufacturing or information systems.

This application claims the benefit of and priority to U.S. Provisional Application No. 60/485,326 filed Jul. 7, 2003, the contents of which are incorporated herein by reference in their entirety.

### GOVERNMENT INTERESTS

The United States Government may have certain rights to this invention pursuant to work funded by the Office of Space and Naval Warfare Systems Command under Contract No. N00039-03-C-0022.

### INTRODUCTION

The present invention relates to methods for mining real-world databases that have mixed data types (e.g., scalar, binary, category, etc.) to extract an implicit time-sequence to the data and to utilize the extracted information to compute categories for the input data and to predict categorization of future input data vectors. Many real-world databases may not have explicit time data yet there may be inherent time data which may be extracted from the database itself. The present invention extracts such inherent time sequence data and utilizes it to classify the data vectors at each instant in time for purposes of categorizing the data at that time instant. The present invention has wide applicability and may find use in fields such as manufacturing, financial services, or government. In particular, the present invention may be used to identify potential threats, to predict the presence of a threat, and even to evaluate the degree of threat posed. For purposes of this discussion, the threats may be security threats or other adverse events occurring at a particular company, location, or systems, such as a manufacturing or information systems.

### BACKGROUND OF THE INVENTION

As security threats have become more prevalent and destructive, efforts to identify such threats and implement precautionary measures to mitigate the threats have arisen. However, security breaches, such as the risks posed by terrorism, computer hackers, and others, may arise in a variety of ways, from a variety of sources, and in a variety of degrees. Efforts to identify such threats at early stages, to presumably improve the chance of preventing damage, have included monitoring a variety of data sources, such as communications channels, e-mail traffic, financial data, and other data sources. For example, available communications data may include band width, signal to noise ratio, type of signal, signal direction and/or speed.

As the data collected increases in volume and becomes more abstract in content, deriving meaningful and useful information from such data becomes problematic. These efforts are further complicated when, as is frequently the case, there is not explicit time-sequence data collected. Without an understanding of the time-sequence, the relationship between the various data may not be fully appreciated until an actual security breach has occurred.

Accordingly, what is needed is a system and method for separating time-sequence data from collected data and utilizing the available input information to appropriately categorize the input data vector. That is, a system and method are needed in which a virtual learning machine can construct certain categories (such as threat, non-threat, type of threat, threatened subject, etc.) and in which future input data vectors can be appropriately placed in the constructed category.

### SUMMARY OF THE INVENTION

The present invention utilizes dual virtual learning machines to define categories of real-world data and predict the categorization of future data by exploiting implicit time-series classification data. The present invention uses a computer (or virtual learning machine) to create a higher order polynomial network to identify optimal hyperplanes which categorize the data, and statistical regularization to improve the effective and efficient learning of the virtual learning machine. In addition, a cosine error metric and vector quantization are used to evaluate the effectiveness of the virtual learning machine and improve its learning and converge the data into its appropriate categories.

Once the input data vectors have been classified, a second computer (or virtual learning machine) called a regression machine, predicts the categories in which future unknown data vectors will be placed. In addition, the regression machine will not only classify data vectors at that instant time, but will also predict from the current data any future categories which may be necessary.

### BRIEF DESCRIPTION OF THE DRAWINGS

FIG. 1 is a graphical representation of the relationship between the input space, the feature space and the output space.

FIG. 2 is a graph of the magnitude against time of sample scalar data used in a prototype of the present invention plotted against time.

FIG. 3 is a graph of the convergence of the learning machine in the examples discussed herein.

FIG. 4 is a subset of a scalar data on which the present invention was tested.

### DETAILED DESCRIPTION OF THE INVENTION

The present invention is comprised of two virtual learning machines for purposes of conducting data mining and analysis. The first machine, also referred to herein as the “categorizer,” classifies each of the input data vectors. The second machine, also referred to herein as the “regression machine,” acts as a time series predictor of the classes. The present invention predicts in which classes input data vectors are properly categorized utilizing inherent time-sequence data derived from the input data set. Accordingly, the categorizer must generate classes for categorizing the input data vectors. In addition to generating several classes, the categorizer learns how to categorize the input data vectors.

The categorizer uses a self-organizing polynomial network to build and identify classes from the raw input data. The basic principal behind the categorizer is finding an optimal hyperplane such that the expected classification error for future input data vectors is minimized. That is, the categorizer seeks to arrive at a good generalization of the known input data allowing accurate categorization of unknown input data vectors.

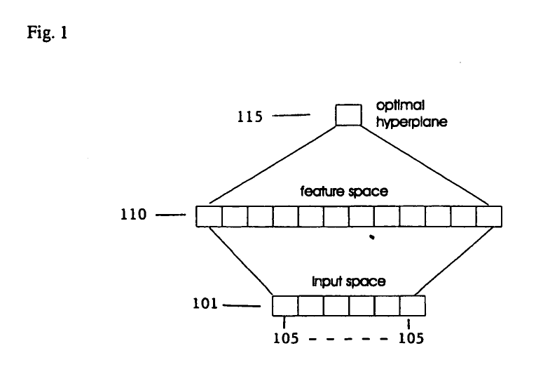

The categorizer accepts as input data (n×1) data vectors. These (n×1) data vectors define an n-dimensional input space which is spanned by the input data vectors. The task of categorizing the (n×1) input data vectors requires deriving optimal hyperplanes which separate the input vectors into appropriate classifications. However, often an n-dimensional space is not a high enough dimensionality to separate the (n×1) input data vectors by hyperplanes. To circumvent this problem, the input space is shattered by a polynomial of higher degree. This higher degree polynomial essentially maps the input space into a higher order space using a non-linear transform such as that set forth in Equation 1 below.
ζ¹=x¹, . . . , ζⁿ=xⁿ n coordinates
ζⁿ⁺¹(x¹)², . . . , ζ²ⁿ=(xⁿ)² n coordinates
ζ²ⁿ⁺¹=x¹x², . . . , ζⁿ=xⁿxⁿ⁻¹n(n+1)/2 coordinates [Eq. 1]
In effect, Equation 1 takes the input values, computes their cross products creating a new space for constructing the hyperplanes. This new space will have dimensionality, as indicated in Equation 1, of n(n+1)/2 where n is the dimension of the input space. It is within this derived space, known as the feature space, where optimal hyperplanes will be derived for classifying the input data vectors. Once the number of classifications desired is determined, a n-m-p polynominal network is created where n is the dimension of the input space, m is the dimension of the feature space and p is the dimension of the category space (also known as the output space). The relationship between the input space, the feature space and the category space is shown in FIG. 1. As shown in FIG. 1, the input space 101 is defined by the (n×1) input data vectors 105. The input space 101, is mapped to the feature space, 110. Within the feature space 110 hyperplanes 115 are derived. The hyperplanes 115 define the data categories and thus the category space (not shown).

Once the category space is defined by the optimal hyperplanes, the task of training the virtual learning machine in the higher dimensional feature space still exists. However, because the feature space is now, likely linear, simple algorithms can be used to find the weights (i.e., defining the relationship between the feature space and category space). Instead of manually determining the weights, the learning machine concept is used to simplify the mathematical computations. In particular, a self-organizing network is used. Using classic Kohonen network training, the weights between the feature space and category space (also known as the output space) can usually be computed by the following equation:
wⱼₖ(t+1)=wⱼₖ(t)+η(zⱼ−wⱼₖ(t))
Δwⱼₖ=η(aⱼ−wⱼₖ(t)) Eq. [2]
This equation provides that the weight at the next time instant is a function of the weight at the current time instant, plus the product of a learning factor, l, and the difference between the input to a connection (for the feature space) and the weight of the current time.

Statistical regularization of the weights calculated above will improve the effectiveness of the learning machine in a higher dimensional space. For example, the following equation can be used to regularize the weights:
wⱼₖ(t+1)=wⱼₖ(t)+η(zⱼ−wⱼₖ(t))−γ|w| Eq. [3]
where |w| is known as the weight norm and is typically computed as follows

$$\vert w \vert = {\sum }_{jk} {w}_{jk}^{2} \qquad Eq . [ 4 ]$$

The error used to compute the weight difference for a regression machine is usually a Euclidian norm in the appropriate space. However, the categorizer described above is self-organizing meaning there is no predetermined output category with which to compare the results of the categorizer to determine if mistakes were made. Thus, the above categorizer is actually constructed of a hybrid machine where the learning rule is a vector quantization algorithm:

$$Δ {w}_{jk} = \{ \begin{matrix}η ( {z}_{j} - {w}_{jk} ( t ) ) & if answer correct \\ - η ( {z}_{j} - {w}_{ij} ( t ) ) & otherwise\end{matrix} \qquad Eq . [ 5 ]$$

In order to apply the this vector quantization algorithm, the following procedure is utilized. For each input vector, an associated output data vector is created. A database of input and associated output vectors is created with each randomly selected input vector. Since the output vectors are retained, each time the input vector is selected, a comparison between the new output estimate and the old output estimate, utilizing a comparison function such as the Euclidian norm, can be performed. As the Euclidian norm between the new output estimate and the old output estimate is minimized, the learning machine will converge after a number of iterations. For example, given an input vector Xᵢ and output vector Yₜ, there is generated at time t output vector Yₜ. This output vector Yₜ is then compared to the output vector Yₜ₋ₙ which was generated the last time input vector Xᵢ was selected. In this example, n is time interval which has passed between the prior selection of input vector Xᵢ and the current selection of Xᵢ.

Although any known Euclidian metric will be useful in describing the convergence of the data vectors the invention utilizes a more robust metric to measure this convergence. In particular, a cosine error metric such as set forth below, is utilized where θ is the angle between the two vectors in the appropriate hyperspace. This angle can be computed as follows:

$$cos θ = \frac{{\sum }_{i} {y}_{1 , i} {y}_{2 , i}}{{( {\sum }_{i} {y}_{1 , i}^{2} )}^{1 / 2} {( {\sum }_{i} {y}_{2 , i}^{2} )}^{1 / 2}} \qquad Eq . [ 6 ]$$

In order to exploit this as an error metric the vector quantization equation was modified as follows:

$$Δ {w}_{jk} = \{ \begin{matrix}η ( {z}_{j} - {w}_{jk} ( t ) ) & if cos θ > T \\ - η ( {z}_{j} - {w}_{ij} ( t ) ) & otherwise\end{matrix} \qquad Eq [ 7 ]$$

where T represents a threshold.

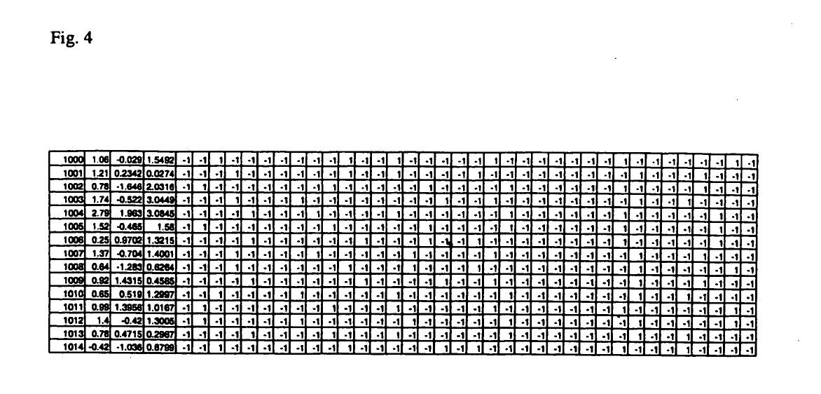

By way of example, a database of 10,000 records each with forty fields was constructed. FIG. 4 shows an example of a subset of this data base which contains scalar, binary, and category data.

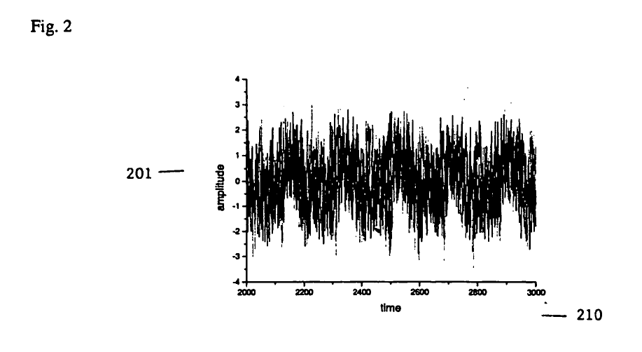

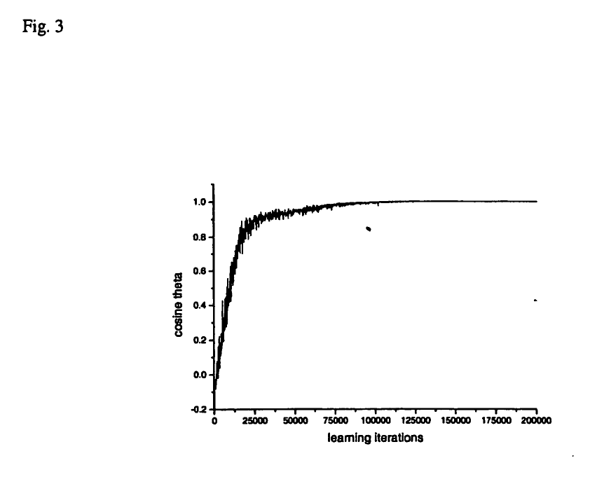

In this example, the category data has been converted to binary data. FIG. 2 shows the magnitude 201 for the three scalar numbers plotted as a function of time 210 for a window of the data. As can be seen from FIG. 2, the data appears noisy, yet periodic. This indicates intrinsic time sequence information on the data set. This database was presented to the categorizer described above as 41-dimension input vectors (the 40 data fields and an additional bias input data field). The 41-dimensional space represents the input space. In order to categorize into hyperplanes, Equation 1 is utilized resulting in a feature space of dimensionality 861. For purposes of this example, 20 categories have been selected, resulting in a 41-861-20 polynomial network with 17,220 connections. As the input data set has approximately 10,000 samples, there would be roughly 17 times as many adjustable parameters as there are data samples. The hyperplanes with optimal weights are derived as described above. Finally, utilizing the cosine error metric described above at Equation 6 and Equation 7, and setting the threshold T=0.9, FIG. 3 shows the learning curve for the classifier indicating that the learning machine converges after approximately 100,000 iterations or approximately 10 iterations per input vector.

Once the category space has been created, the regression machine will accept input data vectors, predict the category in which it belongs from implicit time series classification data. The regression machine utilizes a time delay neural network, to predict categorization and even future categories. The time delay neural network operates by capturing a window, or subset, of data from the output set of the categorizer. In this instance, the output set of the categorizer is a series of ordered pairs of input vectors and associated output vectors. This data subset collected by the time delay neural network consists of input and output vectors starting at time t and going back in time to t−w, where w is the selected window width. The network then trains with an output vector either t or t+n where n is the selected distance into the future.

Utilizing the combination of the categorizer and the regression machine, real world data without explicit time-series classification data can be utilized to make predictions such as regarding potential security threats. The category space will be created from known data regarding known security threats to create categories such as threat, no threat, and degrees or types of threat posed by potential security risks. Once the category space has been created, real world data will be fed through the regression machine which will predict, based on the input data vector, within which category the potential threat is placed.

It is to be understood that this invention, as described herein, is not limited to only the methodologies or protocols described, as these may vary. It is also understood that the terminology used in this description is for the purpose of describing the particular versions or embodiments only, and it is not intended to limit the scope of the present invention. In particular, although the present invention is described in conjunction with potential security threats, it is to be appreciated that the present invention may find use in predicting the categorization of events based on real world data lacking explicit time-series classification data.

1. A system and method for predicting and categorizing security threats comprising:
a first virtual learning machine for classifying existing input data vectors utilizing inherent time-sequence classification data to classify the input data vector as representing a threat or no-threat and the type of threat posed wherein the first virtual learning machine utilizes a higher order self-organizing polynomial network to construct hyperplanes which categorize the input data vectors;
a second virtual learning machine which a time-series predictor utilizing a time delay, neural network to predict the classification of future input data vectors as representing a threat or no-threat and type of threat posed without human intervention.
